(19) United States
(12) Patent Application Publication
(10) Pub. No.: US 2002/0003083 A1
(43) Pub. Date: Jan. 10, 2002

(54) Door switch for refrigerator

(75) Inventor: Jae Sang Park, Sungnam (KR)

Correspondence Address: FLESHNER & KIM, LLP, P.O. Box 221200, Chantilly, VA, 20153-1200, US

(73) Assignee: LG Electronics Inc.

(21) Appl. No.: 09/897,974

(22) Filed: Jul. 5, 2001

(30) Foreign Application Priority Data
Jul. 6, 2000 (KR) 38597/2000

(51) Int. Cl. H01H 3/16

(52) U.S. Cl. 200/61.76

(57) ABSTRACT

A door switch for a refrigerator includes a case having a hole on one side; switch terminal units installed inside the case and making on/off operations of a circuit; a plunger for changing the on/off operations of the circuit mechanically while moving inward/outward of the case through the hole on the case; and a restriction means installed on the case for restricting the movement of the plunger, whereby a chamber light can be turned off even if the door of refrigerator is opened, and therefore power consumption of the refrigerator can be reduced.

### BACKGROUND OF THE INVENTION

1. Field of the Invention

The present invention relates to a door switch for a refrigerator, and particularly, to a door switch for a refrigerator which turns on/off a light inside the refrigerator according to opening/closing of the door.

2. Description of the Background Art

Generally, a chamber light is installed inside the refrigerator so that a user is able to recognize contents stored in the refrigerator by turning on the light when the door of the refrigerator is opened.

The light as described above is turned on/off according to the operation of a door switch which is installed on a wall inside the refrigerator or on a front part of the main body and operates the switch on, whereby the light is turned on.

FIGS. 1 and 2 are longitudinal sectional view showing a conventional door switch for refrigerator.

As shown in FIG. 1, the door switch for a refrigerator of conventional art is assembled inside a case 1 wherein a switch body 10 and a switch cover 11 is assembled with each other.

A plunger 12 penetrating the switch cover 11 from the inside the switch body 10 is disposed protrusive on the case 1.

The plunger 12 is a part where the refrigerator door is directly contacted, and it is moved inside the case 1 or is protruded outside the case 1 in accordance with opened/closed states of the door.

An elastic member 13, which is compressed by the plunger 12 when the door is closed, and provides an elastic force so that the plunger is able to be protruded out of the case 1 when the door is opened, is installed inside the case 1.

In addition, a contact protrusion 12a protrusive to a radial direction from the part located inside the case 1 is formed on the plunger 12.

A contact operation lever 14 rotated by the contact protrusion 12a when the plunger 12 is moved is installed inside the case 1, and the contact operation lever is provided elastic force so as to adhere to the contact protrusion 12a.

Also, a movable contactor 15 and a fixed contactor 16 are installed inside the case 1 so that the chamber light switch is turned on/off in accordance with the rotation of the contact operation lever 14.

The operation of the door switch for refrigerator according to the conventional art as described above will be described as follows.

As shown in FIG. 2, when the door of refrigerator is closed, the plunger 12 is moved inward of the case 1 as being pushed by the door, and at that time, the contact protrusion 12a pushes the contact operation lever 14 to right direction. Accordingly, the contact operation lever 14 is rotated to counter-clockwise direction, whereby the movable contactor 15 is apart from the fixed contactor 16.

At that time, the door switch is turned off, whereby the chamber light is also turned off.

On the contrary, as shown in FIG. 1, when the door is opened, the plunger 12 is protruded out of the case 1 by the restoring force of the elastic member 13. In addition, the contact operation lever 14 is rotated to counterclockwise direction, and at the same time, the movable contactor 15 is restored by the elastic force of itself, whereby the movable contactor 15 is adhered to the fixed contactor 16.

At that time, the door switch is turned on, and therefore the chamber light is also turned on.

However, according to the door switch for the refrigerator of conventional art, the plunger 12 is protruded out of the case when the door is opened, and the light is always turned on. Therefore, the light is turned on when the light is not needed, for example, when the door is opened at daytime or it is bright around the refrigerator.

That is, an additional equipment, which is able to turn off the light in case that a user does not want to turn on the light in the state that the door is opened, is not installed, and therefore the chamber light is always turned on whenever the door is opened, and regardless of the user's will, whereby the power consumption is increased.

### SUMMARY OF THE INVENTION

Therefore, an object of the present invention is to provide a door switch for a refrigerator which is able to lower the power consumption by constructing such that a chamber light is not turned on according to choice of a user, even if the door is opened.

To achieve object of the present invention, as embodied and broadly described herein, there is provided a door switch for a refrigerator includes: a case having a hole on one side; a switch terminal unit installed inside the case and making on/off operation of a circuit; a plunger changing the on/off operation of the switch terminal unit mechanically while moving inward/outward of the case through the hole on the case; and a restriction means disposed on the case for restricting the movement of the plunger.

According to an embodiment of the present invention, the restriction means is moved linearly along with a guide means disposed on the case, whereby the hole is opened/closed.

In addition, according to another embodiment of the present invention, the restriction means is connected to the case using a hinge, whereby the hole on the case is opened/closed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a longitudinal sectional view showing operating state of the door switch when the door is opened;

FIG. 2 is a longitudinal sectional view showing operating state of the door switch when the door is closed;

FIG. 3 is a perspective view showing operating state of the door switch when the door is opened according to a first embodiment of the present invention;

FIG. 4 is a cross-sectional view of line A-A in FIG. 3;

FIG. 5 is a perspective view showing a state that the operation of the door switch is broken according to the first embodiment of the present invention;

FIG. 6 is a cross-sectional view of line B-B in FIG. 5;

FIG. 7 is a cross-sectional view showing a state that the operation of the door switch is broken according to a second embodiment of the present invention;

FIG. 8A is a perspective view showing the door switch according to a third embodiment of the present invention;

FIG. 8B is a cross-sectional view of line C-C in FIG. 8A; and

FIG. 9 is a cross-sectional view showing the door switch according to fourth embodiment of the present invention.

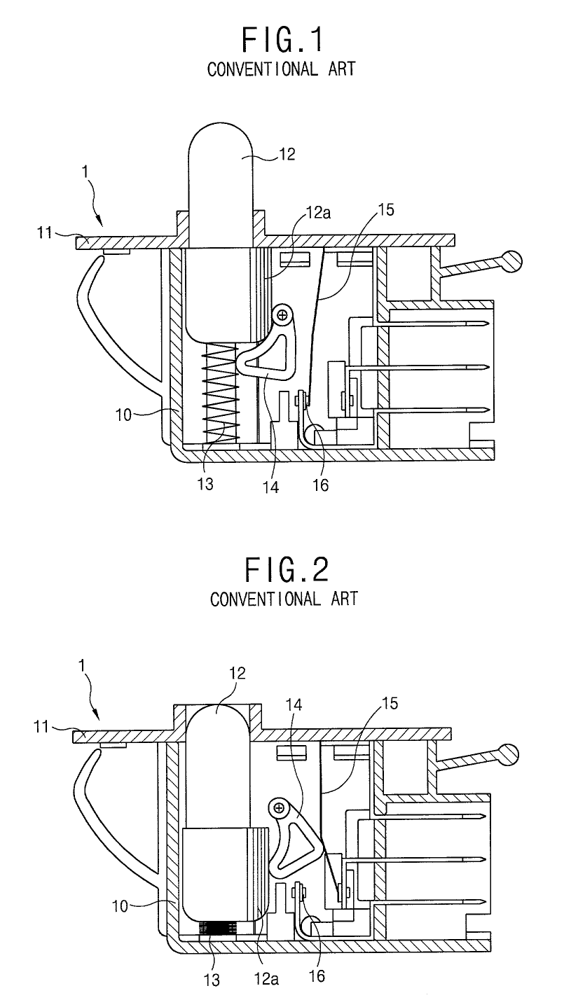

### DETAILED DESCRIPTION OF THE PREFERRED EMBODIMENTS

Reference will now be made in detail to the preferred embodiments of the present invention, examples of which are illustrated in the accompanying drawings.

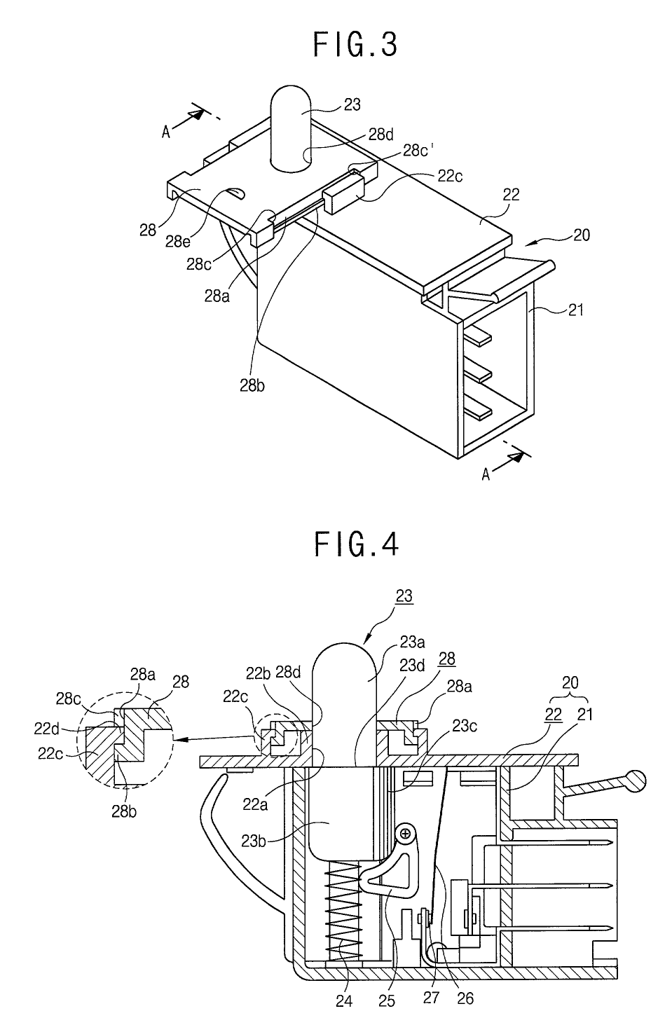

The door switch for a refrigerator according to the first embodiment of the present invention will be described with reference to FIG. 3 through FIG. 6.

FIGS. 3 and 4 are drawings showing the operating state of the door switch when the door is opened. FIG. 3 is a perspective view showing the door switch for the refrigerator according to the present invention, and FIG. 4 is a cross sectional view of line A-A in FIG. 3.

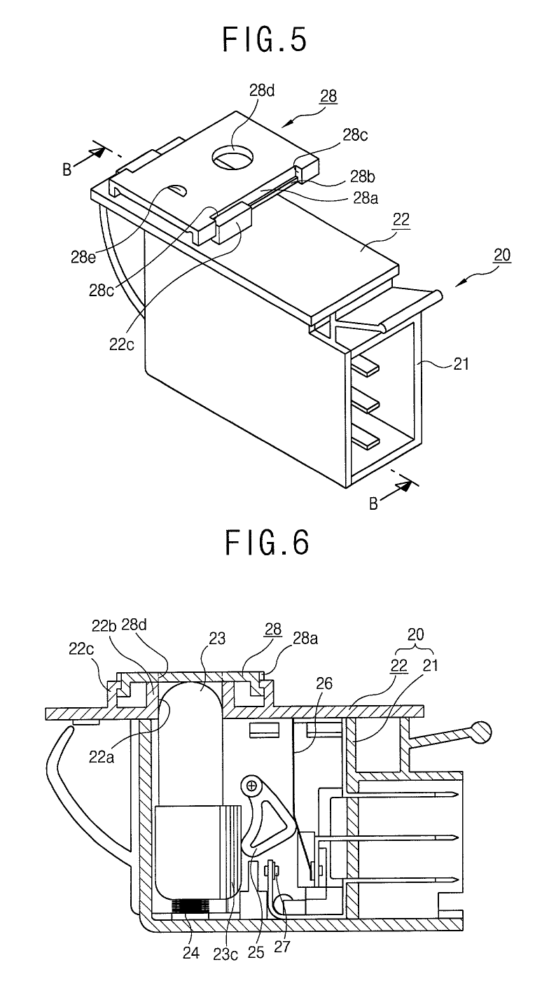

In addition, FIGS. 5 and 6 are drawings showing a state that the operation of the door switch is prevented. FIG. 5 is a perspective view showing the door switch according to the present invention, and FIG. 6 is a crosssectional view of line B-B in FIG. 5.

The door switch according to the present invention is constructed such that the plunger 23 protrusive upwardly from the case 20 is moved to inside/outside of the case 20 in accordance with opening/closing of the door, and at the same time, the movable contactor 26 and the fixed contactor 27 connected to the plunger 23 mechanically are contacted or separated according to the operation of the plunger 23.

That is, the plunger protrusive out of the case 20 is linearly moved according to opening/closing of the door, and rotates the contact operation lever 25 to right/left directions, whereby the movable contactor 26 is separated/contacted from/to the fixed contactor 27.

Herein, as shown in FIG. 4, the plunger is divided into two parts, that is, a part 23a exposed out of the case 20 and a part 23b always inserted inside the case 20. In addition, a stopper 23d is formed between the two parts so that the plunger 23 is not came out of the case by caught on the case 20.

Especially, a contact protrusion 23c rotating the contact operation lever 25 is formed on the part 23b inserted inside the case 20 of the plunger 23, expanded from the part 23b to radial direction.

The plunger 23 is provided a force to move outside the case 20 by an elastic member 24 supported inside the case 20.

In addition, a contact operation lever 25 rotated by the contact protrusion 23c when the plunger 23 is moved is installed inside the case 20, and the contact operation lever 25 is provided elastic force so as to adhere to the contact protrusion 23c always.

On the other hand, the case is made by assembling a switch body 21 and a switch cover 22 with each other.

A plunger passage hole 22a is formed on the switch cover 22 so that the plunger 23 is protrusive out of the case 20.

A plunger guide 22b is formed on boundary of the switch passage hole 22a protrusive out of the case in order to support the plunger 23 so that the protruded part of the plunger 23 is not damaged, and to guide the moving passage of the plunger 23.

Especially, a pair of guide rails 22c of a certain height are formed on both sides of the plunger guide 22b on upper surface of the switch cover 22.

The pair of guide rails 22c are formed parallelly with each other, and a guide projection 22d protrusive as facing each other is formed on upper end part of the guide rail.

A restriction plate 28 is inserted between the pair of guide rails 22c so as to prevent the protrusion of the plunger 23 out of the case 20.

The restriction plate 28 is formed to have a length longer than that of the guide rails 22c. In addition, both sides of the restriction plate 28 are flanged as cranks, and have guide recesses 28a coupled to the guide projection 22d of the guide rails 22c in length direction.

The guide recesses 28a is formed to have length longer than that of the guide rail 22c, and a moving restriction projections 28c and 28c' are formed on both ends of the recesses 28a so that the guide recesses 28a are caught on the guide projections 22d of the guide rails 22c.

Herein, the moving restriction projections 28c restrict the moving range of the restriction plate 28 along with the guide rails 22c, and at the same time, prevents the restriction plate 28 from seceding from the guide rails 22c.

Also, the guide recesses 28a are formed long on the upper part on side surface of the restriction plate 28, accordingly, a stopping projection 28b is formed long on lower part of the side surface of the restriction plate 28 so as to be caught on bottom surface of the guide projections 22d of the guide rails 22c.

On the other hand, the bottom surface of the restriction plate 28 is plan and is supported by the upper end part of the plunger guide 22b.

Therefore, the bottom surface of the restriction plate 28 is supported by the plunger guide 22b in the state that the stopping projections 28b on both sides are caught by the guide projections 22d of the guide rails 22d, whereby the moving in vertical direction of the plunger 23 is restrained.

In addition, the restriction plate 28 is able to move to horizontal direction, that is, crossed direction with the moving direction of the plunger 23 along with the guide rails 22c.

Especially, a plunger releasing hole 28d having same size with the plunger passage hole 22a of the switch cover 22 is formed on the restriction plate 28.

As shown in FIG. 3, it is desirable that the plunger releasing hole 28d is formed on a position corresponding to that of the plunger passage hole 22a when the restriction plate 28 is not able to move because the moving restriction projection 28c' of the restriction plate 28 and the end part of the guide rails 22c are adhered to each other.

In addition, it is desirable that the plunger releasing hole 28d has a diameter through which the plunger 23 is able to pass, but the plunger guide 22b is not able to pass.

Therefore, the restriction plate 28 is able to move along with the guide rails 22c, and makes the plunger 23 be protruded through the plunger releasing hole 28d as shown in FIG. 3 or restricts the plunger 23 so that the plunger is inserted in the case 20 by blocking the plunger passage hole 22a, as shown in FIG. 5.

On the other hand, a handle recess 28e of concave shape may be formed on upper surface of the restriction plate 28 so that the user is able to operate easily.

Operation and effect of the door switch for a refrigerator according to the present invention will be described as follows.

The door switch 20 for the refrigerator is installed on the wall inside a chilling chamber or on front surface of the main body so that the door is contacted to the switch.

As shown in FIGS. 3 and 4, in order to turn on/off the chamber light in accordance with opening/closing of the door, the restriction plate 28 is moved to correspond the plunger releasing hole 28d to the plunger passage hole 22a, so that the plunger 23 of the door switch is able to turn on/off the switch while moving according to the opening/closing state of the door.

At that time, when the door is closed, the plunger 23 rotates the contact operation lever 25 while being pushed into the case 20, and then the movable contactor 26 is separated from the fixed contactor 27, whereby the switch of the chamber light is turned off and the light is also turned off.

On the contrary, when the door is opened, the plunger 23 is protruded outside of the case 20 by the restoring force of the elastic member 24 through the plunger passage hole 22a of the case and through the plunger releasing hole 28d of the restriction plate 28, and at that time, the movable contactor 26 is also contacted to the fixed contactor 27 by the elastic force of itself, whereby the chamber light is turned on.

In addition, in order to turn off the chamber light even if the door is opened, as shown in FIGS. 5 and 6, the user blocks the plunger passage hole 22a by moving the restriction plate 28 along with the guide rails 22c in the state that the user pushes the plunger 23 into the case 20.

At that time, the protrusion of the plunger out of the case is restricted by the bottom surface of the restriction plate 28, and the movable contactor 26 is separated from the fixed contactor 27 as shown in FIG. 6, whereby the chamber light is turned off even if the door is opened.

The operation described above may be needed when the user uses the refrigerator at daytime or when it is bright around the refrigerator.

If the user wants to turn on the chamber light when the door is opened from the state described above, as shown in FIG. 4, the user makes the plunger releasing hole 28d of the restriction plate 28 be located on upper part of the plunger passage hole 22a by moving the restriction plate 28, whereby the plunger 23 is protruded out of the case when the door is opened and the chamber light is turned on.

A second embodiment of the door switch for a refrigerator according to the present invention will now be described.

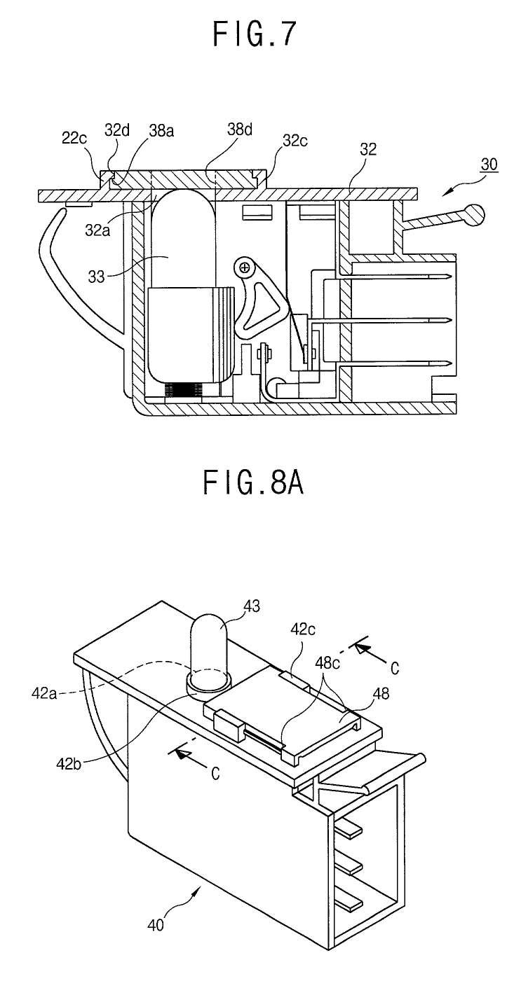

FIG. 7 is a cross-sectional view showing a state that the operation of the door switch is prevented according to the second embodiment of the present invention.

The door switch according to the second embodiment of the present invention does not include the plunger guide 22b included in the first embodiment, and an restriction plate 38 is installed adhering directly on upper surface of a switch cover 32.

Therefore, the restriction plate 38 is moved as sliding in the state that both sides of the plate 38 are inserted into a guide rails 32c, and restricts or releases the moving of the plunger 33.

Of course, a plunger releasing hole 38d is formed on the restriction plate 38 so that the plunger 33 is protruded out of the case 30.

In case that the plunger releasing hole 38d of the restriction plate 38 corresponds to a plunger passage hole 32a of the case 30, the plunger releasing hole 38d guides moving of the plunger 33 like the plunger guide in the first embodiment, and at the same time, supports the plunger 33.

In the second embodiment, the height of the guide rails 32c supporting the restriction plate 38 is formed lower than that of the guide rails in the first embodiment.

Guide projections 32d are protruded facing each other on the upper end part of the guide rail 32c and are coupled to the guide recesses 38a formed on both sides of the restriction plate 38, whereby the guide rails 32c guides the moving of the restriction plate 38 to left/right directions.

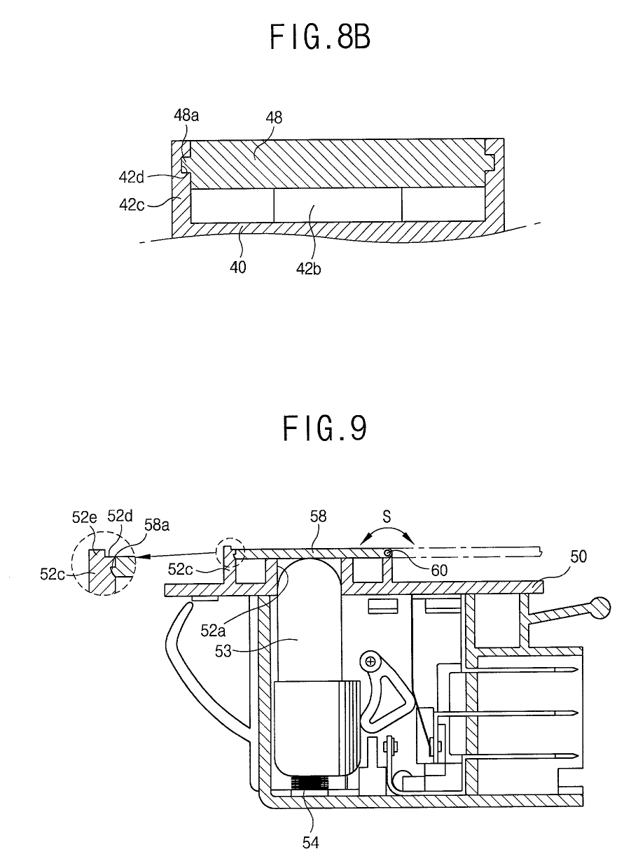

A door switch for a refrigerator according to third embodiment of the present invention will be described with reference to FIG. 8.

FIG. 8A is a perspective view showing the door switch for the refrigerator according to the third embodiment of the present invention, and FIG. 8B is a cross-sectional view of line C-C in FIG. 8A.

The door switch for the refrigerator according to the third embodiment of the present invention is constructed unlike those of first and second embodiments, such that an restriction plate 48 is moved frontward/backward in the length direction of a case 40, and is able to restrict or release a plunger 43. Especially, the restriction plate 48 does not include the plunger releasing hole.

That is, a pair of guide rails 42c are formed on both sides of the case 40 in the length direction, and the restriction plate 48 is inserted between the guide rails 42c. And as shown in FIG. 8B, a recess 42d and a protrusion 48a coupled with each other as concave/convex structure are formed on the guide rails 42c and on the restriction plate 48 respectively, whereby the linear movement of the restriction plate 48 is guided.

Of course, moving restriction projections 48c are formed on both end part of the protrusions on the restriction plate 48 so that the restriction plate 48 is not seceded from the guide rails, and at the same time, the movement range is restricted.

Therefore, if the restriction plate 48 is moved to right in FIG. 8A, the plunger guide 42c and the plunger passage hole 42a are opened and the plunger 43 is able to move freely. However, if the restriction plate 48 is moved to left, the plunger passage hole 42a is blocked and the movement of the plunger 43 out of the case is restricted.

A door switch for a refrigerator according to fourth embodiment of the present invention will be described with reference to FIG. 9.

FIG. 9 is a cross-sectional view showing the door switch for refrigerator according to the fourth embodiment of the present invention.

The door switch for a refrigerator according to the fourth embodiment of the present invention is opened/closed using a hinge, and therefore it is constructed different from the sliding structure in first, second, and third embodiments.

That is, in the door switch for a refrigerator according to the fourth embodiment of the present invention, an restriction plate 58 is connected to upper part of the case 50 using a hinge 60 and is opened/closed to ′S' in FIG. 9, whereby the plunger passage hole 52a is opened.

Herein, a front end part of the restriction plate 58 is coupled to the stopping protrusion part 52c protruded from the case 50 using a hook, and therefore the opening of the restriction plate 58 is prevented.

The hook structure includes a hook 58a formed on the restriction plate 58 and a stopping projection 52d formed on the stopping protrusion part 52c, and the state that the restriction plate 58 is blocking the plunger passage hole 52a is maintained.

On the other hand, an asperity part 52e is formed on upper end part of the stopping protrusion part 52c, therefore if the user presses to ° F. direction in FIG. 9, the asperity part 52e is turned over and the restriction plate 58 is released.

As described above, in case that the stopping protrusion part 52c does not restrict the restriction plate 58, the plunger 53 is protruded out of the case while pushing the restriction plate 58 by the elastic member 54, whereby the plunger 53 turns on/off the chamber light according to the opening/closing of the door.

According to the door switch of the present invention, the chamber light is able to be turned on/off in the state that the door is opened by operating the restriction plate, and therefore the user is able to use the refrigerator more conveniently.

Also, according to the door switch of the present invention, the user is able to turn off the chamber light even if the door is opened, and therefore the power consumption caused by turning on the chamber light inefficiently can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A door switch for a refrigerator comprising a case having a hole on one side;
switch terminal units installed inside the case and making on/off operation of a circuit;
a plunger changing the on/off operation of the switch terminal units mechanically while moving inward/outward of the case through the hole on the case; and
a restriction means included in the case and restricting the movement of the plunger.

2. The door switch according to claim 1, wherein the restriction means is able to open/close the hole on the case.

3. The door switch according to claim 1, wherein the restriction means is able to open/close the hole while moving linearly along with a guide means disposed in the case.

4. The door switch according to claim 2, wherein the restriction means is formed as a plate, and the guide means includes a pair of rails supporting both sides of the restriction means and guiding linear movement of the restriction means.

5. The door switch according to claim 4, wherein a recess and a protrusion formed long in moving direction of the restriction means are formed on the restriction means and on the guide means respectively, and the restriction means is able to move along with the guide means through a guide structure in which the recess and the protrusion are coupled to each other.

6. The door switch according to claim 4, wherein one of the recess and the protrusion is formed on the restriction means, and it is formed longer than a coupled part formed on the guide means so that the restriction means is able to move in a certain range along with the guide means.

7. The door switch according to claim 1, wherein the restriction means moves linearly to the direction of crossing the length direction of the case and restricts the movement of the plunger.

8. The door switch according to claim 1, wherein the restriction means is moved linearly to the length direction of the case and restricts the movement of the plunger.

9. The door switch according to claim 1, wherein the restriction means is connected to the case using a hinge and is able to open/close the hole of the case.

10. The door switch according to claim 9, wherein a stopping means is formed on the case so that the state that the restriction means blocks the hole can be maintained.

11. The door switch according to claim 10, wherein the stopping means and the restriction means are constructed by coupling a hook and a stopping projection.

12. The door switch according to claim 11, wherein the stopping means is protruded long from the case and is able to release the restriction means by giving pressure to opposite direction of the restriction means.
